(19) United States
(12) Patent Application Publication
(10) Pub. No.: US 2017/0215562 A1
(43) Pub. Date: Aug. 3, 2017

(54) DRY AND WET LAND GEAR HOLDER

(71) Applicant: Jerald Blakely Williams, Holcomb, MS (US)

(72) Inventor: Jerald Blakely Williams, Holcomb, MS (US)

(21) Appl. No.: 15/344,029

(22) Filed: Nov. 4, 2016

Related U.S. Application Data
(60) Provisional application No. 62/388,574, filed on Feb. 2, 2016.

(51) Int. Cl. A45F 3/44; A47B 83/00; F16M 11/28; G03B 17/56; A47C 3/40; A47C 3/34; A01M 31/00; F41A 23/06; A47B 81/00; A47C 1/14

(52) U.S. Cl. CPC A45F 3/44; A47B 81/00; A47B 83/00; F16M 11/28; A47C 1/14; A47C 3/40; A47C 3/34; A01M 31/00; F41A 23/06; G03B 17/561; A45F 2003/001

(57) ABSTRACT

A dry and wet land gear holder for supporting equipment for a hunter or wildlife observation enthusiasts. The holder includes an upper and lower support members that are telescopically extensible and retractable relative one another. The lower support member has a plurality of outwardly extending legs supporting the holder in a vertical orientation. A plurality of pegs for supporting the user's gear. The holder may be configured with an accessory that is received within a top end of the holder. The accessory may include a camera mount, a sighting rest, and a horizontal support platform, which may be configured as a work surface or a seat. The legs and bottom end of the lower support member may have ground penetrating tips to secure the holder in an upright position relative a ground surface.

### CROSS-REFERENCE TO RELATED APPLICATION

This application claims the benefit of priority of U.S. provisional application No. 62/388,574, filed Feb. 2, 2016, the contents of which are herein incorporated by reference.

### BACKGROUND OF THE INVENTION

The present invention relates to outdoor sporting and wildlife observation equipment and, more particularly, to a holder for the support of outdoor sport and wildlife observation equipment and accessories.

Currently in the art, hunters carry all types of gear but have nothing to hold it in a convenient, readily accessible place once they have reached a desired hunting location. Available alternatives rely on hooks or posts than need to be screwed into a tree, restricting where a hunter can set up and potentially damaging the tree. If the hunter is not near a tree or does not plan to hunt near one then they have nothing to hold their gear. This presents a greater challenge during or following periods of precipitation where the ground may be wet, or where the area selected for hunting may be located in marshy or wetland areas.

As can be seen, there is a need for an improved outdoor sports equipment holder that allows a hunter to hunt near a tree, in the middle of a field, in water, or in a ground blind.

### SUMMARY OF THE INVENTION

In one aspect of the present invention, a gear holder, includes an upstanding lower support member formed as an elongate substantially hollow tube having an upper end a lower end. A plurality of legs extend downwardly and outwardly from the lower end portion of the lower support member. A horizontal stub is configured to extend laterally from a lower portion of the lower support member. An upper support member is telescopically received within the lower support member and the upper support member has a plurality of laterally extending pegs disposed in a spaced apart relationship around a top end of the upper support member. The gear holder may also include a fastener that extends through a lateral sidewall of the lower support member and is configured to secure the upper support member in selected extension relative to the lower support member. The fastener can be a bolt that is threadingly received in a threaded aperture, which extends through the lateral sidewall of the lower support member.

In some embodiments, the bolt is an eye hook. In other embodiments, the fastener may be a pin that is received through the lateral sidewall and be received in a bore extending into the upper support member.

In other aspects of the invention, the plurality of legs extend beyond the lower end of the lower support member. The plurality of legs may include a ground penetrating tip defined at a bottom end of the legs. The lower support member may also be defined with a ground penetrating tip. The pegs may extend upwardly and outwardly from the upper support member.

In still other aspects of the invention, an accessory may be received in a top end of the upper support member. The accessory may be a camera mount, an arcuate sighting rest, or a horizontal support platform, which may be a seat or a work surface.

In yet other aspects of the invention, a gear holder is claimed, which includes an elongate upright support member with a plurality of legs extending outwardly from a lower end portion of the upright support member and downwardly beyond a lower end of the upright support member. An upper support member is telescopically extensible from the upright support member, with the upper support member having a plurality pegs laterally disposed in a spaced apart relationship around a top end of the upper support member. A fastener retains the upper support member at a desired extension. In some embodiments, a horizontal stub extends laterally from a lower portion of the upright support member and a ground penetrating tip is defined at a free end of the plurality of legs. In preferred embodiments, an accessory is received in a top end of the upper support member. The accessory may be one of a camera mount, a sighting rest, or a horizontal support platform.

These and other features, aspects and advantages of the present invention will become better understood with reference to the following drawings, description and claims.

### BRIEF DESCRIPTION OF THE DRAWINGS

FIG. 1 is a front perspective view of an embodiment of an outdoor sporting equipment holder according to aspects of the invention.

FIG. 2 is a rear perspective view of gear holder.

FIG. 3 is a front perspective view of the gear holder in an extended mode.

FIG. 4 is a detail cross-sectional view taken on line 4-4 of FIG. 1.

FIG. 5 is a front perspective view of an embodiment configured with a camera accessory.

FIG. 6 is a front perspective view of an embodiment with a firearm support accessory.

FIG. 7 is a front perspective view of an embodiment with a seat accessory.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved dry and wetland gear holder that is lightweight, portable, and sturdy. The gear holder is designed to be quickly and easily set up and holds gear without the need of a tree or the worry of losing your gear. The dry and wetland gear holder gives the hunter the ability to extend it to their desired height and to hang all of their gear in one safe and nearby place without the need for a tree. This allows the hunter to go anywhere they please and still have something to readily hold all of their gear. This will improve on the hunting experience by allowing hunters to shed their gear, without worry of what will happen to it. The present invention can hold a gun, a bow, or any other gear and accessories that a hunter may have with them during a hunting session or season.

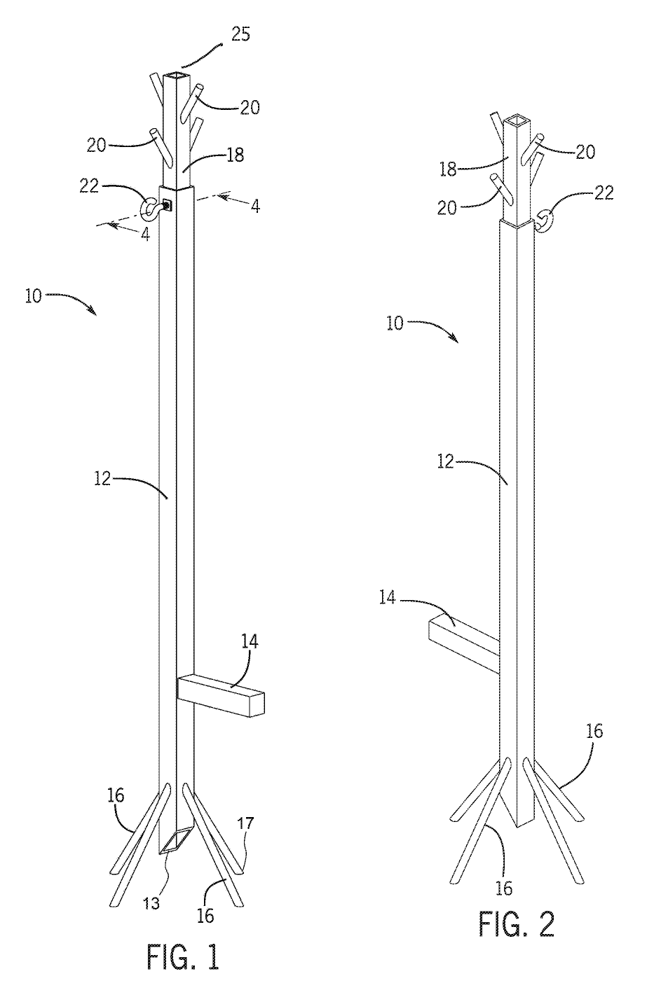

As seen in reference to the drawings of FIGS. 1-3, the gear holder 10 of the present invention includes an upright support member 12, which is formed as an elongate substantially hollow tube, which may have a rectangular or any suitable cross sectional shape. The support member 12 has an upper end a lower end. The lower end of the support member 12 may include a chisel or angled tip 13, configured for penetration of a ground surface.

A plurality of legs 16 extend downwardly and outwardly from a lower end portion of the support member 12, with a bottom end of the legs 16 extending beyond a lower end 13 of the support member 12. The legs 16 may also include a chisel or angled tip 17 configured for penetration of the ground surface.

A horizontal stub 14 extends laterally from a lower portion of the upright support member 12. During set up of the holder 10, the horizontal stub 14 may be utilized as a foot brace to enable the hunter to urge the leg tips 17 into the ground surface to enhance stability of the holder 10. Once the stand is set up, the stub 14 may be also be utilized to support additional hunting gear and accessories carried by the hunter.

An upper portion of the lower support member 12 is configured to telescopically receive an upper support member 18 therein. A fastener 22, such as a bolt or pin, is configured to extend through a sidewall of the lower support member 12 and engage with the upper support member 18 to retain the upper support member 18 at a desired extension or retraction relative the upper end of the lower support member. The upper support member 18 may be extensible from between about 2 to 5 feet in height.

Preferably, the fastener 22 is threadingly received in a threaded aperture 24 extending through the sidewall of the lower support member 12, as shown in reference to FIG. 4. More preferably, the fastener 22 is an eyehook to provide an additional holding location, for accessories that may be carried with a lanyard or strap, such as a game call, binoculars, a canteen, or the like. The upper support member 18 may also include a plurality of aligned bores 19 dimensioned to receive an end of the fastener 22.

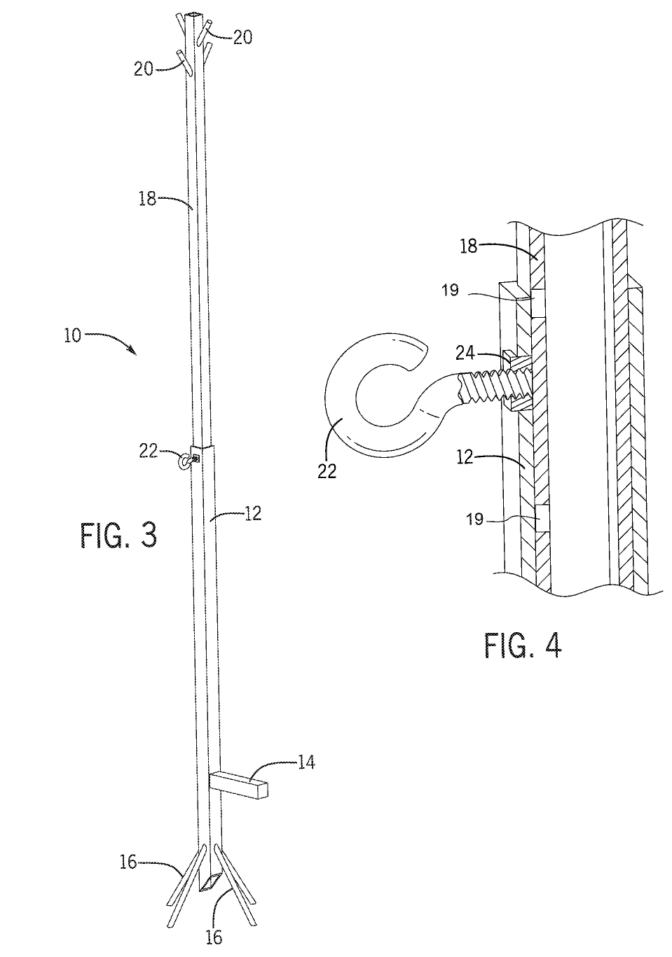

A top end of the upper support member 18 is provided with a plurality of pegs 20 laterally extending from a sidewall of the upper support member 18. The pegs 20 provide a location for the carriage of a strap or other suitable holding device of larger gear, such as a backpack, equipment bags, a sling for a firearm, and the like. More preferably, the pegs 20 extend upwardly and are disposed in a spaced apart relation around a circumferential surface of the upper support member 18. As seen in reference to FIGS. 2 and 3, the upper support member 18 may be adjustably extended and retracted from within the lower support member 12 and secured in a desired elevation via the fastener 22.

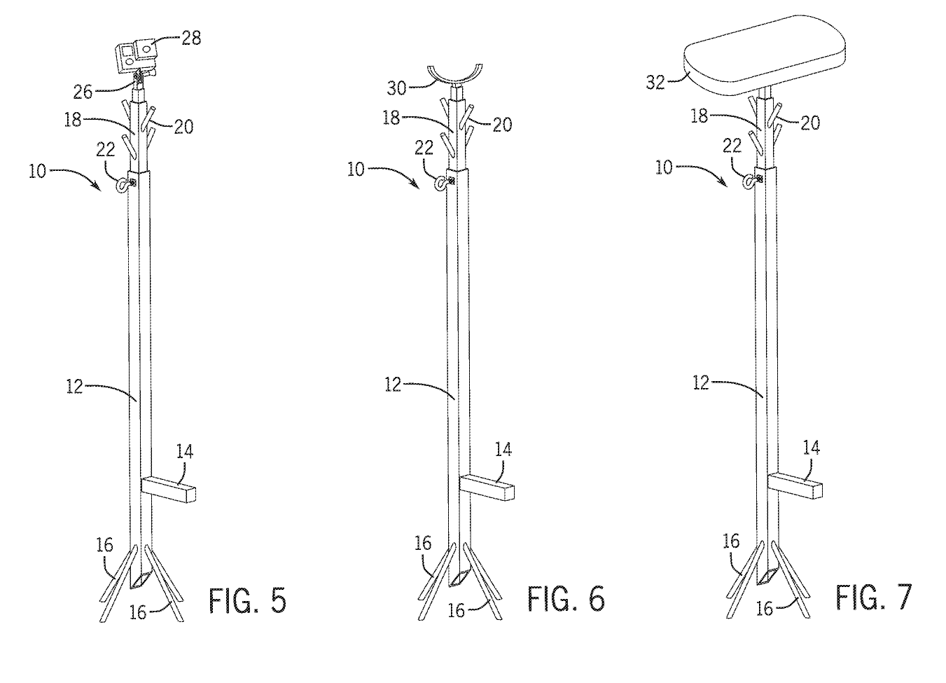

As seen in reference to FIG. 5-7, a top end 25 of the upper support member may be configured to receive a gear holder accessory. As shown in FIG. 5, the gear holder accessory may include a camera mount 26 configured to adjustably attach a camera 28 to the gear holder 10. The gear holder accessory may also include a firearm aiming rest 30, such as shown in FIG. 6, which may include an upwardly opening arcuate portion for supporting a portion of a firearm or an optical viewing device while sighting on a game animal. In reference to FIG. 7, the gear holder accessory may also include a horizontal support platform 32, which may be configured as a seat 32 for the user to sit upon, or alternatively as a working surface for writing and related observation activities.

In use, the present invention provides a free-standing, extendable holder that is configured to carry all of a hunter's or wildlife observer's gear in one safe and convenient place.

It should be understood, of course, that the foregoing relates to exemplary embodiments of the invention and that modifications may be made without departing from the spirit and scope of the invention as set forth in the following claims.

What is claimed is:

1. A gear holder, comprising:
an upstanding lower support member formed as an elongate substantially hollow tube having an upper end a lower end;
a plurality of legs extend downwardly and outwardly from the lower end portion of the lower support member;
a horizontal stub extending laterally from a lower portion of the lower support member;
an upper support member telescopically received within the lower support member, the upper support member having a plurality of laterally extending pegs disposed in a spaced apart relationship around a top end of the upper support member.

2. The gear holder of claim 1, further comprising:
a fastener extending through a lateral sidewall of the lower support member configured to secure the upper support member in selected extension relative to the lower support member.

3. The gear holder of claim 2, wherein the fastener comprises a bolt threadingly received in a threaded aperture extending through the lateral sidewall of the lower support member.

4. The gear holder of claim 3, wherein the bolt is an eye hook bolt.

5. The gear holder of claim 2, wherein the fastener comprises a pin received through the lateral sidewall and be received in a bore extending into the upper support member.

6. The gear holder of claim 2, wherein the plurality of legs extend beyond the lower end of the lower support member.

7. The gear holder of claim 5, wherein the plurality of legs further comprise a ground penetrating tip defined at a bottom end of the legs.

8. The gear holder of claim 6, wherein the bottom end of the lower support member is defined with a ground penetrating tip.

9. The gear holder of claim 1, wherein the pegs extend upwardly and outwardly.

10. The gear holder of claim 8, further comprising:
an accessory received in a top end of the upper support member.

11. The gear holder of claim 10, wherein the accessory is a camera mount.

12. The gear holder of claim 10, wherein the accessory is an arcuate sighting rest.

13. The gear holder of claim 10, wherein the accessory is a horizontal support platform.

14. The gear holder of claim 13, wherein the horizontal support platform is a seat.

15. A gear holder, comprising:
an elongate upright support member;
a plurality of legs extend outwardly from a lower end portion of the upright support member and downwardly beyond a lower end of the upright support member;
an upper support member telescopically extensible from the upright support member, the upper support member having a plurality pegs laterally disposed in a spaced apart relationship around a top end of the upper support member; and
a fastener to retain the upper support member a desired extension.

16. The gear holder of claim 15, further comprising:
a horizontal stub extending laterally from a lower portion of the upright support member; and
a ground penetrating tip defined at a free end of the plurality of legs.

17. The gear holder of claim 16, further comprising:
an accessory received in a top end of the upper support member.

18. The gear holder of claim 17, wherein the accessory is a camera mount.

19. The gear holder of claim 17, wherein the accessory is an arcuate sighting rest.

20. The gear holder of claim 17, wherein the accessory is a horizontal support platform.
